(19) United States
(12) Patent Application Publication
(10) Pub. No.: US 2024/0405894 A1
(43) Pub. Date: Dec. 5, 2024

(54) INDICATOR CIRCUIT AND CALIBRATION METHOD FOR CALIBRATING NON-LINEAR DEVIATION OF POWER DETECTION CIRCUIT

(71) Applicant: Realtek Semiconductor Corp., HsinChu (TW)

(72) Inventors: Sheng-Lung Cheng, HsinChu (TW); Ling Lee, HsinChu (TW)

(73) Assignee: Realtek Semiconductor Corp., HsinChu (TW)

(21) Appl. No.: 18/671,958

(22) Filed: May 22, 2024

(30) Foreign Application Priority Data
May 31, 2023 (TW) 112120257

(51) Int. Cl. H04B 17/10; H04B 17/13

(52) U.S. Cl. CPC H04B 17/102; H04B 17/13

(57) ABSTRACT

An indicator circuit includes a power detection circuit and a codeword mapping circuit. The power detection circuit is coupled to a signal output terminal of a transmitter circuit, and is arranged to detect a power of an output signal to generate a detection result. The codeword mapping circuit is arranged to generate an indicator codeword according to the detection result, wherein the codeword mapping circuit converts the detection result according to a plurality of non-linear bases to correspondingly generate a plurality of converted detection results, and combines the plurality of converted detection results to generate the indicator codeword.

### BACKGROUND OF THE INVENTION

### 1. Field of the Invention

The present invention is related to a transmit signal strength indicator (TSSI) circuit, and more particularly, to a TSSI circuit that can calibrate non-linear deviation of a power detection circuit within an indicator circuit

### 2. Description of the Prior Art

Wireless communication standards have high requirements for accuracy of power of an output signal of a radio frequency (RF) transmitter. Thus, the RF transmitter is often equipped with a power control mechanism. For example, the RF transmitter may detect the power of the output signal through a power detection circuit to generate a detection result, and determine whether an actual power of the output signal meets an original power setting according to the detection result, in order to ensure accurate output signal power control.

Under an ideal situation, the detection result of the power detection circuit has a linear relationship with the actual power of the output signal of the RF transmitter. However, due to non-ideal effects within the circuit, the actual power of the output signal and the detection result do not have the linear relationship.

### SUMMARY OF THE INVENTION

It is therefore one of the objectives of the present invention to provide a TSSI circuit and an associated calibration method that can calibrate non-linear deviation of a power detection circuit within an indicator circuit.

According to an embodiment of the present invention, an indicator circuit is provided. The indicator circuit comprises a power detection circuit and a codeword mapping circuit. The power detection circuit is coupled to a signal output terminal of a transmitter circuit, and is arranged to detect a power of an output signal to generate a detection result. The codeword mapping circuit is arranged to generate an indicator codeword according to the detection result, wherein the codeword mapping circuit converts the detection result according to a plurality of non-linear bases to correspondingly generate a plurality of converted detection results, and combines the plurality of converted detection results to generate the indicator codeword.

According to another embodiment of the present invention, a calibration method arranged to calibrate non-linear deviation of a power detection circuit is provided. The calibration method comprises: detecting a power of an output signal of a transmitter circuit to generate a detection result; converting the detection result according to a plurality of non-linear bases to correspondingly generate a plurality of converted detection results; and combining the plurality of converted detection results to generate an indicator codeword.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a communication device according to an embodiment of the present invention.

FIG. 2 is a diagram illustrating a corresponding relationship curve between a power of an output signal and a detection result according to an embodiment of the present invention.

FIG. 3 is a diagram illustrating a corresponding relationship curve between a detection result and an indicator codeword according to an embodiment of the present invention.

FIG. 4 is a diagram illustrating a corresponding relationship curve between an indicator codeword and power of an output signal according to an embodiment of the present invention.

FIG. 5 is a flow chart of a calibration method for calibrating non-linear deviation of a power detection circuit according to an embodiment of the present invention.

FIG. 6 is a diagram illustrating an example of a codeword mapping circuit according to an embodiment of the present invention.

FIG. 7 is a diagram illustrating an example of a basis operation circuit according to an embodiment of the present invention.

FIG. 8 is a diagram illustrating elements of a lookup table according to an embodiment of the present invention.

### DETAILED DESCRIPTION

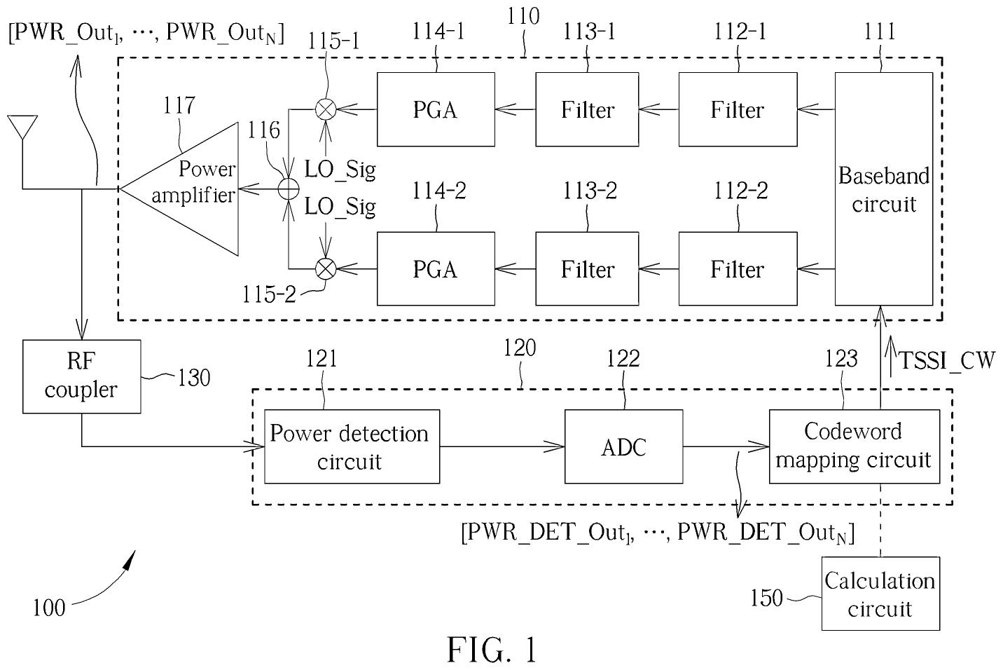

FIG. 1 is a block diagram of a communication device 100 according to an embodiment of the present invention. The communication device 100 may include a transmitter circuit 110 configured on a transmit signal processing path and an indicator circuit 120 configured on a feedback signal processing path. The transmitter circuit 110 may include multiple stages of transmit signal processing devices for processing the transmit signal. According to an embodiment of the present invention, the transmitter circuit 110 may include a baseband circuit 111, multiple digital-to-analog converters (DACs) 112-1 and 112-2 at an in-phase channel I and a quadrature-phase channel Q, respectively, multiple filters 113-1 and 113-2, multiple programmable gain amplifiers (PGAs) 114-1 and 114-2, multiple mixers 115-1 and 115-2, an adder 116, and a power amplifier 117.

The baseband circuit 111 may receive and process a set of input signals at the in-phase channel I and the quadrature-phase channel Q to generate a baseband-processed signal. In addition, the baseband circuit 111 may generate a control signal to control operations of subsequent circuits. For example, operations of the PGAs 114-1 and 114-2 and/or the power amplifier 117 can be controlled by setting gain values used by the PGAs 114-1 and 114-2 and/or the power amplifier 117 through the control signal.

The DACs 112-1 and 112-2 may be arranged to convert the baseband-processed signal from a digital domain to an analog domain at the in-phase channel I and the quadrature-phase channel Q, respectively. The filters 113-1 and 113-2 may be arranged to perform a filtering operation upon the received signal. The PGAs 114-1 and 114-2 may be arranged to adjust the gain value of the received signal. The mixers 115-1 and 115-2 may be arranged to multiply the received signal with an oscillation signal LO Sig, in order to convert the received signal into a radio frequency (RF) signal. The oscillation signals LO Sig provided to the mixers 115-1 and 115-2, respectively, may be two signals with the same frequency and orthogonal phases. In this embodiment, an oscillation frequency of the oscillation signal LO Sig is LO. The adder 116 is arranged to combine the signal on the in-phase channel I and the signal on the quadrature-phase channel Q. The power amplifier 117 is arranged to amplify the RF signal before the RF signal is transmitted through an antenna.

The RF signal output by the power amplifier 117 may be coupled to the indicator circuit 120 through an RF coupler 130. In some embodiments, the RF coupler 130 may be regarded as a device included in the indicator circuit 120. According to an embodiment of the present invention, the indicator circuit 120 may be a transmit signal strength indicator (TSSI) circuit for implementing close-loop power control.

Specifically, the RF signal output by the power amplifier 117 (i.e., an output signal) may be coupled (i.e., fed back) to the indicator circuit 120 through the RF coupler 130. The indicator circuit 120 may include a power detection circuit 121, an analog-to-digital converter (ADC) 122, and a codeword mapping circuit 123. The power detection circuit 121 may be coupled to a signal output terminal of the transmitter circuit 110 (e.g., a signal output terminal of the power amplifier 117) through the RF coupler, and may be arranged to receive an output signal of the power amplifier 117, and detect a power of the output signal to generate a detection result. In an embodiment of the present invention, the power detection circuit 121 may include one or more of an attenuator, an RF rectifier, a mixer, a filter, etc. The attenuator may be arranged to adjust (e.g., amplify or attenuate) the received signal. The RF rectifier may be arranged to perform a rectification operation upon the received signal. The mixer may be arranged to down-convert the received signal into a baseband signal. The filter may be arranged to perform a filtering operation upon the received signal.

The ADC 112 may be arranged to convert the detection result from an analog domain to a digital domain. The codeword mapping circuit 123 may be arranged to generate an indicator codeword TSSI CW according to the detection result, wherein the indicator codeword TSSI CW may be provided to the baseband circuit 111. The baseband circuit 111 may derive a value according to the indicator codeword TSSI CW, and the value reflects the detection result of the power detection circuit 121. The baseband circuit 111 may determine whether an actual output signal power meets an original setting power according to the value to generate a determination result, and generate a control signal according to the determination result, in order to control the operations of the PGAs 114-1 and 114-2 and/or the operations of the power amplifier 117 (e.g., the above-mentioned gain value setting or adjustment).

It should be noted that FIG. 1 is a simplified communication device and only illustrates components related to the present invention. In practice, a communication device may further include components that are not shown in FIG. 1 to implement wireless communication and associated signal processing.

In an ideal situation, the detection result output by the power detection circuit 121 has a linear relationship with the actual output signal power of the transmitter circuit 110. However, due to non-ideal effects in the circuit (e.g., the power detection circuit 121), the detection result output by the power detection circuit 121 may not have the linear relationship with the actual output signal power of the transmitter circuit 110.

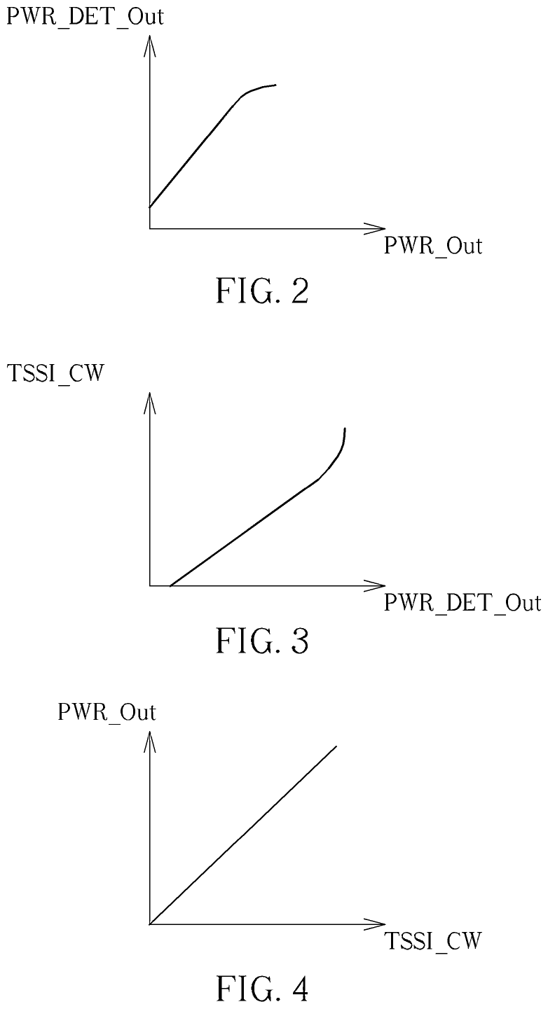

FIG. 2 is a diagram illustrating a corresponding relationship curve between the power of the output signal of the transmitter circuit 110 and the detection result of the power detection circuit 121 according to an embodiment of the present invention, wherein the horizontal axis represents a power PWR Out of the output signal of the transmitter circuit 110, and the vertical axis represents a detection result PWR DET Out of the power detection circuit 121. As shown in FIG. 2, due to the non-ideal effects in the circuit, the detection result PWR DET Out of the power detection circuit 121 has a non-linear corresponding relationship (or a non-completely linear corresponding relationship) with the power PWR Out. Under this situation, the baseband circuit 111 is unable to linearly adjust the output power of the transmit signal (e.g., by adjusting the gain values of the PGAs 114-1 and 114-2 and/or the gain value of the power amplifier 117) according to the detection result PWR DET Out of the power detection circuit 121 (or according to the indicator codeword TSSI CW correspondingly generated according to the detection result PWR DET Out), which causes the problem of insufficient signal output power accuracy.

In order to address this issue, the codeword mapping circuit 123 may convert the detection result PWR DET Out of the power detection circuit 121 according to a plurality of non-linear bases to correspondingly generate a plurality of converted detection results, and combine the plurality of converted detection results to generate the indicator codeword TSSI CW provided to the baseband circuit 111, wherein the plurality of converted detection results and the indicator codeword TSSI CW has a non-linear corresponding relationship.

FIG. 3 is a diagram illustrating a corresponding relationship curve between the detection result PWR DET Out and the indicator codeword TSSI CW according to an embodiment of the present invention, wherein the horizontal axis represents the detection result PWR DET Out, and the vertical axis represents the indicator codeword TSSI_CW (which may be equal to a corresponding value derived from the indicator codeword TSSI CW). As shown in FIG. 3, the codeword mapping circuit 123 may map the detection result PWR DET Out to a corresponding indicator codeword TSSI CW in a non-linear manner (or a non-completely linear manner), such that the detection result PWR DET Out has a non-linear corresponding relationship (or a non-completely linear corresponding relationship) with the indicator codeword TSSI CW (or the corresponding value derived from the indicator codeword TSSI CW). This non-linear corresponding relationship can compensate or calibrate the above-mentioned non-linear corresponding relationship between the power PWR Out and the detection result PWR DET Out, in order to make the power PWR Out have a linear corresponding relationship with the indicator codeword TSSI CW.

FIG. 4 is a diagram illustrating a corresponding relationship curve between the indicator codeword TSSI CW and the power PWR Out according to an embodiment of the present invention, wherein the horizontal axis represents the indicator codeword TSSI CW (or the corresponding value derived from the indicator codeword TSSI CW), and the vertical axis represents the power PWR Out. As shown in FIG. 4, after the calibration operation performed by the codeword mapping circuit 123, the indicator codeword TSSI CW will have a linear corresponding relationship with the power PWR Out of the actual output signal.

In other words, the indicator codeword TSSI CW (or the corresponding value derived from the indicator codeword TSSI CW) may reflect a linear variation of the power PWR Out, or there is a linear corresponding relationship between the indicator codeword TSSI CW and the power PWR Out. For example, in response to the power PWR Out changing, the indicator codeword TSSI CW or a value corresponding to the indicator codeword TSSI CW will change correspondingly in a linear manner, to reflect the variation of the power PWR Out. The change amount of the indicator codeword TSSI_CW (or the value corresponding to the indicator codeword TSSI CW) has a linear corresponding relationship with the change amount of the power PWR Out. In this way, the indicator codeword TSSI CW (or the value corresponding to the indicator codeword TSSI CW) can accurately reflect the power PWR Out, and the variation of the indicator codeword TSSI CW (or the value corresponding to the indicator codeword TSSI CW) can also accurately reflect the variation of the power PWR Out.

In the embodiments of the present invention, the internal circuit design of the analog circuit (e.g., the power detection circuit 121) is not changed, and the above-mentioned non-linear corresponding relationship between the power PWR Out and the detection result PWR DET Out is compensated/calibrated by mapping the detection result PWR DET Out to a corresponding indicator codeword TSSI CW in a non-linear manner (or a non-completely linear manner) through the codeword mapping circuit 123. In this way, the circuit cost can be saved, and the non-linear mapping logic used by the codeword mapping circuit 123 can be adjusted dynamically, adaptively, and flexibly with changes in the analog circuit (e.g., the power detection circuit 121) used by the transmitter circuit 110 (e.g., power detection circuits manufactured by different manufacturers are used), such that the calibration method and the indicator circuit proposed by the present invention have the advantages of low cost and high adaptability.

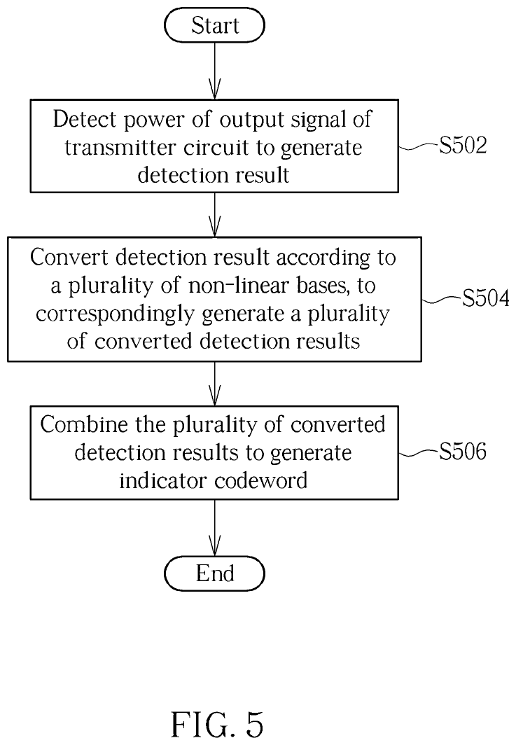

FIG. 5 is a flow chart of a calibration method for calibrating non-linear deviation of a power detection circuit according to an embodiment of the present invention. The flow chart includes the following steps executed by the indicator circuit.

In Step S502, a power of an output signal of a transmitter circuit is detected to generate a detection result.

In Step S504, the detection result is converted according to a plurality of non-linear bases to correspondingly generate a plurality of converted detection results.

In Step S506, the plurality of converted detection results are combined to generate an indicator codeword.

According to an embodiment of the present invention, when Step S506 is executed, the codeword mapping circuit 123 may further be arranged to generate the indicator codeword (e.g., the indicator codeword TSSI_CW) according to a plurality of coefficients (e.g., C₀-C_{K}), wherein the plurality of coefficients are arranged to weight the plurality of converted detection results.

According to an embodiment of the present invention, the plurality of non-linear bases are bases of different orders. In Steps S504 and S506, the codeword mapping circuit 123 generates the indicator codeword in a non-linear corresponding manner, wherein the non-linear corresponding manner can be represented as the following K-order operation:

$$TSSI\_CW = {C}_{0} + {\sum }_{k = 1}^{K} {C}_{k} {ϕ}_{k} ( PWR\_DET \_Out ) \qquad equation ( 1 )$$

wherein ϕₖ(⋅) is the k-order non-linear basis, C₀, . . . , C_{K} are coefficients of corresponding bases, and K is related to a degree of the non-linear deviation of the analog circuit (e.g., the power detection circuit) within the indicator circuit. The larger the value of K is, the more serious the nonlinear deviation of the circuit is. If K=1, the indicator codeword TSSI_CW will have a linear corresponding relationship with the detection result PWR_DET_Out.

In the embodiments of the present invention, ϕₖ(⋅) may be designed according to a measurement result of the actual circuit. In an embodiment of the present invention, ϕ₁(⋅)˜ϕ_{K}(⋅) may be non-linear polynomials of different orders. For example, general polynomials (equation (2)) and shifted Legendre polynomials (equation (3)) are represented as follows:

$${ϕ}_{k} ( x ) = {x}^{k} \qquad equation ( 2 )$$

$${ϕ}_{k} ( x ) = {\sum }_{j = 0}^{k} {x}^{j} \frac{- {1}^{k + j} ( k + j ) !}{{( j ! )}^{2} ( k - j ) !} \qquad equation ( 3 )$$

In addition, the communication device 100 may be further coupled to an external calculation circuit 150, and the external calculation circuit 150 is arranged to calculate the coefficients C₀-C_{K}. In order to obtain the coefficients C₀-C_{K}, the transmitter circuit 110 may output N sets of signals by different powers for acting as test signals, and record the output powers measured at the antenna terminal. Refer back to FIG. 1. Assume that the output powers measured at the antenna terminal are represented as [PWR_Out₁, . . . , PWR_Out_{N}], and the detection outputs of the power detection circuit 121 are represented as [PWR_DET_Out₁, . . . , PWR_DET_Out_{N}]. The coefficients C₀-C_{K} can be obtained by the least square error calculation (equation (4)) represented as follows:

$$C = {( {H}^{T} \cdot H )}^{- 1} \cdot {H}^{T} \cdot y = {[ {C}_{0} , … , {C}_{K} ]}^{T} \qquad equation ( 4 )$$

wherein operation ( )^{T} is the transpose operation of a vector or a matrix, and y is a vector of the indicator codeword TSSI_CW. As shown in the following equation (5), indicator codewords TSSI_CW_Ideal(PWR_Out₁), . . . , TSSI_CW_Ideal(PWR_Out_{N}) are ideal indicator codewords linearly corresponding to the output powers [PWR_Out₁, . . . , PWR_Out_{N}] (e.g., indicator codewords obtained by linear conversion).

$$equation ( 5 )$$

$$y = {[ TSSI\_CW \_Ideal ( {PWR\_Out}_{1} ) , … , TSSI\_CW \_Ideal ( {PWR\_Out}_{N} ) ]}^{T}$$

In addition, the matrix H in the equation (4) is a matrix of size (N×(K+1)), and contents of the matrix H can be represented as follows:

$$H = [ \begin{matrix}1 & {ϕ}_{1} ( PWR\_DET {\_Out}_{1} ) & … & {ϕ}_{K} ( PWR\_DET {\_Out}_{1} ) \\ 1 & {ϕ}_{1} ( PWR\_DET {\_Out}_{2} ) & … & {ϕ}_{K} ( PWR\_DET {\_Out}_{2} ) \\ ⋮ & & & \\ ⋮ & ⋮ & … & ⋮ \\ 1 & & & \\ 1 & {ϕ}_{1} ( PWR\_DET {\_Out}_{N} ) & … & {ϕ}_{K} ( PWR\_DET {\_Out}_{N} )\end{matrix} ] \qquad equation ( 6 )$$

As mentioned above, ϕₖ(⋅) is a known function designed according to the measurement result of the actual circuit, and all of the signal output powers [PWR_Out1, . . . , PWR_OutN], the detection outputs [PWR_DET_Out1, . . . , PWR_DET_OutN], and the vector y of the ideal indicator codeword are known values. Thus, the calculation circuit 150 may calculate the coefficients C₀-C_{K} according to the equation (4). After the coefficients C₀-C_{K} are obtained, the calculation circuit 150 may no longer be coupled to the communication device 100, and the codeword mapping circuit 123 may further use the equation (1) to generate the corresponding indicator codeword TSSI_CW in a non-linear manner (or a non-completely linear manner) according to the actual detection result of the power detection circuit 121.

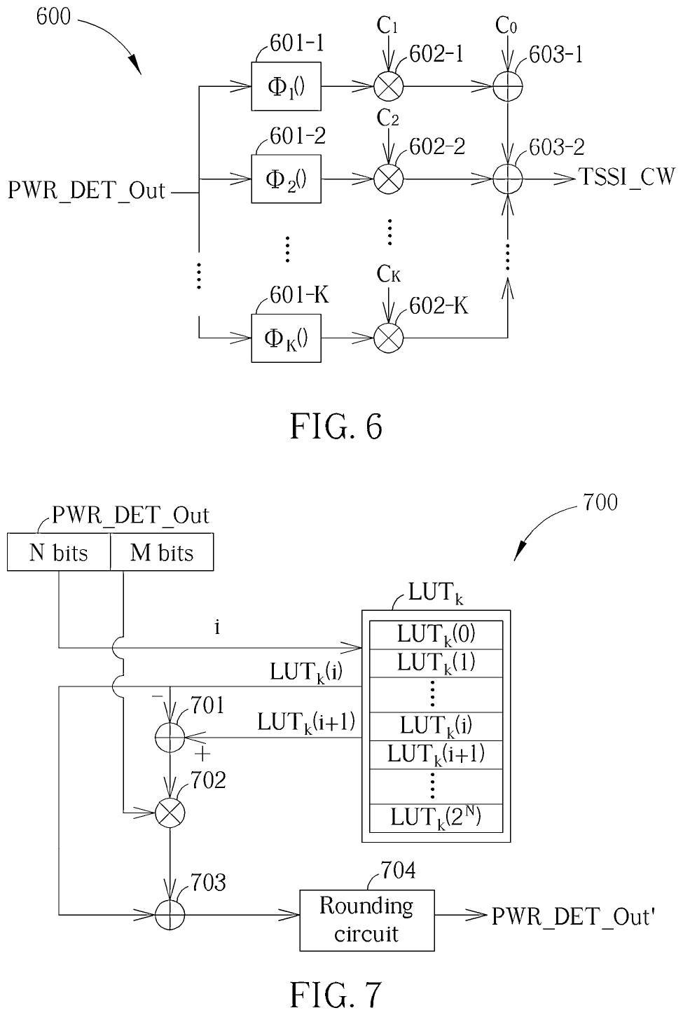

FIG. 6 is a diagram illustrating an example of a codeword mapping circuit 600 according to an embodiment of the present invention. As shown in FIG. 6, the codeword mapping circuit 600 may include a plurality of basis operation circuits 601-1, 601-2, . . . , and 601-K, a plurality of multipliers 602-1, 602-2, . . . , and 602-K, and a plurality of adders 603-1, 603-2, . . . . The basis operation circuits 601-1, 601-2, . . . , and 601-K may be designed according to contents of ϕ₁(⋅)˜ϕ_{K}(⋅), respectively, to perform corresponding basis operations. In an embodiment of the present invention, the codeword mapping circuit 600 may implement operations of the equation (1). When the detection result PWR_DET_Out of the power detection circuit is input, the codeword mapping circuit 600 may output the corresponding indicator codeword TSSI_CW according to logics shown in the equation (1).

In another embodiment of the present invention, the minimum/maximum input and the minimum/maximum output of each non-linear basis can be normalized to a value between 0 and 1, and contents of each non-linear basis can be appropriately quantized and stored in a corresponding lookup table, in order to further simplify the design of the basis operation circuits in the codeword mapping circuit 600.

Specifically, assuming that the detection result PWR_DET_Out is a binary value including a plurality of bits, wherein the plurality of bits include multiple first bits of a first number and multiple second bits of a second number, the first bits at least include the most significant bit (MSB) in the plurality of bits (e.g., the first bits are N more significant bits starting from the MSB), and the second bits at least include the least significant bit (LSB) in the plurality of bits (e.g., the second bits are M less significant bits starting from the LSB).

According to an embodiment of the present invention, when the codeword mapping circuit 123 converts the detection result according to the non-linear bases, the codeword mapping circuit 123 may obtain a first value and a second value according to the first number of first bits, obtain a difference value between the first value and the second value, calculate an offset according to the second bits and the difference value, and generate a corresponding converted detection result in the plurality of converted detection results according to the first value and the offset.

According to an embodiment of the present invention, the first value is directly related to the first number of first bits, and the first value and the second value are set according to a corresponding non-linear basis in the plurality of non-linear bases. For example, the codeword mapping circuit 123 may include one or more lookup tables, wherein each lookup table may correspond to one of the plurality of non-linear bases, and each lookup table may include a plurality of elements set according to the non-linear bases, for storing quantized results of the non-linear bases. For example, both the first value and the second value are recorded in a corresponding lookup table for acting as a part of the elements, wherein a number of elements is determined according to the first number.

FIG. 7 is a diagram illustrating an example of a basis operation circuit 700 according to an embodiment of the present invention. In this embodiment, the basis operation circuit 700 can be designed according to contents of the non-linear basis ϕₖ(⋅), in order to perform corresponding basis operations. Assume that the detection result PWR_DET_Out is a binary value including (M+N) bits, and the (M+N) bits include the first N more significant bits (e.g., the above-mentioned first bits including the MSB in the detection result PWR_DET_Out) and the last M less significant bits (e.g., the above-mentioned second bits including the LSB in the detection result PWR_DET_Out). The basis operation circuit 700 may include a lookup table LUTₖ, and the lookup table LUTₖ may include (2^{N}+1) fields for storing (2^{N}+1) elements.

An actual example is provided for illustration. Assuming that the detection result PWR_DET_Out is a binary value including 8 bits (e.g., M=4 and N=4), a number of elements included in the lookup table LUTₖ is (2⁴+1)=17, and each element is defined as a binary value including 12 bits. As mentioned above, the minimum/maximum input and the minimum/maximum output of each non-linear basis can be normalized to a value between 0 and 1. As a result, both the maximum input and the maximum output of the non-linear basis ϕₓ(⋅) are normalized to 1. In addition, assuming that the non-linear basis ϕₖ(⋅) is general polynomials of k=3 (i.e., ϕ₃(x)=x³). The contents of the non-linear basis ϕ₃(x) can be moderately quantized to 17 elements.

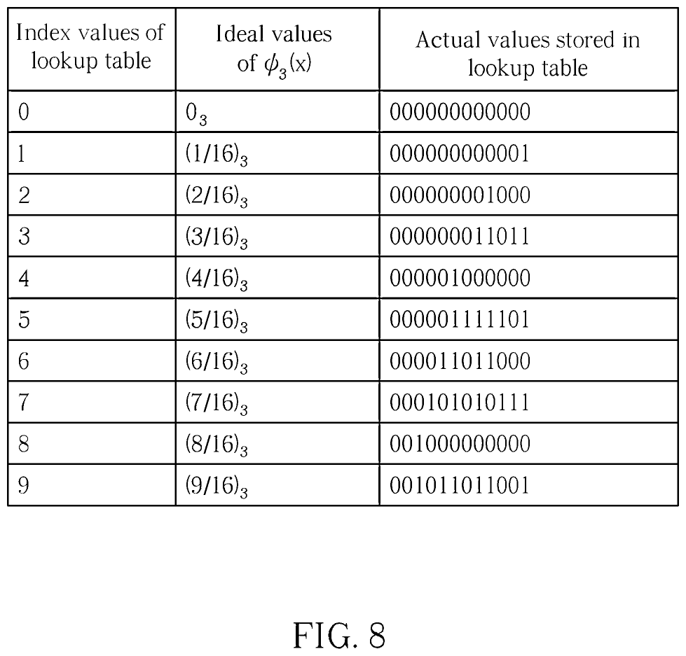

FIG. 8 is a diagram illustrating elements of the lookup table LUTₖ according to an embodiment of the present invention, wherein the left fields represent index values of the lookup table LUTₖ, the right fields represent actual values stored in the lookup table LUTₖ (i.e., contents of elements that are set according to the non-linear basis ϕₖ(x), wherein k=3), and the middle fields represent ideal values of the non-linear basis ϕ₃(x) corresponding to the elements, respectively. Assume that a binary value of the detection result PWR_DET_Out currently output by the power detection circuit is equal to “01111010”, and a decimal value corresponding to the binary value is “122”. The ideal value of the non-linear basis ϕ₃(x) is (122/256)³=0.108.

When the codeword mapping circuit 122 converts the detection result according to the non-linear bases, the corresponding converted detection result generated by the basis operation circuit shown in FIG. 7 can be applied. Since the first 4 (N=4) bits of the detection result is “0111” (which corresponds to a decimal value “7”), the codeword mapping circuit 123 may take the decimal value “7” corresponding to the first 4 bits “0111” as an index value i of the lookup table LUTₖ, and obtain a corresponding first value LUTₖ(i) and a corresponding second value LUTₖ(i+1) from the lookup table LUTₖ (e.g., LUT₃(7)=000101010111 and LUT₃(8)=001000000000). An adder 701 may obtain a difference value between the first value LUTₖ(i) and the second value LUTₖ(i+1) by performing a binary subtraction operation (e.g., LUT₃(8)−LUT₃(7)=000010101001). Since both the first value LUTₖ(i) and the second value LUTₖ(i+1) are values that are set according to the non-linear basis ϕ₃(x) and corresponding index values (i) and (i+1), and the first value LUTₖ(i) is a value found from the lookup table LUTₖ according to a value corresponding to the first 4 bits “0111” of the detection result, the first value LUTₖ(i) is directly related to the first 4 bits “0111” (i.e., the first bits) of the detection result, and the second value LUTₖ(i+1) is indirectly related to the first bits.

A multiplier 702 may perform a binary multiplication operation to multiply the last 4 (M=4) bits “1010” of the detection result with the difference value output by the adder 701 to calculate an offset (e.g., [LUT₃(8)−LUT₃(7)]×1010=0000011010011010). An adder 703 may perform a binary addition operation to add the first value and the offset to obtain an addition result that is equivalent to a result of linear interpolation based on the first value and the second value (e.g., LUT₃(7)+0000011010011010=0001110000001010). Since a number of bits of the first value is different from that of the offset, the MSB of the first value should be aligned with that of the offset before the binary addition operation is performed (i.e., four zeros are added after the first value). The output of the adder 703 is rounded into a 12-bit value through a rounding circuit 704 for acting as a final output PWR_DET_Out′ (which is the above-mentioned converted detection result, such as ϕₖ(PWR_DET_Out) in the equation (1)). For example, PWR_DET_Out′=000111000001 (which corresponds to a decimal value “449”), and a normalized and rounded value is (449/4096)=0.1096, which is close to the ideal value (122/256)³=0.108 of the non-linear basis ϕ₃(x).

In the embodiments of the present invention, the internal circuit design of the analog circuit (e.g., the power detection circuit 121) is not changed, and the non-linear corresponding relationship between the power PWR_Out and the detection result PWR_DET_Out is compensated/calibrated by mapping the detection result PWR_DET_Out to a corresponding indicator codeword TSSI_CW in a non-linear manner (or a non-completely linear manner) through the codeword mapping circuit 123. In this way, the circuit cost can be saved, and the non-linear mapping logic used by the codeword mapping circuit 123 can be adjusted dynamically, adaptively, and flexibly with changes in the analog circuit (e.g., the power detection circuit 121) used by the transmitter circuit 110 (e.g., power detection circuits manufactured by different manufacturers are used), such that the calibration method and the indicator circuit proposed by the present invention have the advantages of low cost and high adaptability. In addition, in some embodiments, a lookup table can be utilized to simplify the design of the basis operation circuits in the codeword mapping circuit 600, such that the circuit complexity of the codeword mapping circuit can be further reduced and the production cost can be further saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An indicator circuit, comprising:
a power detection circuit, coupled to a signal output terminal of a transmitter circuit, and arranged to detect a power of an output signal to generate a detection result; and
a codeword mapping circuit, arranged to generate an indicator codeword according to the detection result, wherein the codeword mapping circuit converts the detection result according to a plurality of non-linear bases to correspondingly generate a plurality of converted detection results, and combines the plurality of converted detection results to generate the indicator codeword.

2. The indicator circuit of claim 1, wherein the power of the output signal has a non-linear corresponding relationship with the detection result, the detection result has a non-linear corresponding relationship with the indicator codeword, and the power of the output signal has a linear corresponding relationship with the indicator codeword.

3. The indicator circuit of claim 1, wherein when the power of the output signal changes, a value corresponding to the indicator codeword changes correspondingly in a linear manner.

4. The indicator circuit of claim 1, wherein the plurality of non-linear bases are bases of different orders.

5. The indicator circuit of claim 1, wherein the detection result is a binary value, the binary value comprises a plurality of bits, the plurality of bits comprise multiple first bits of a first number and multiple second bits of a second number, the multiple first bits at least comprise a most significant bit (MSB) in the plurality of bits, the multiple second bits at least comprise a least significant bit (LSB) in the plurality of bits; and when the codeword mapping circuit converts the detection result according to the plurality of non-linear bases, the codeword mapping circuit obtains a first value and a second value according to the multiple first bits, obtains a difference value between the first value and the second value, calculates an offset according to the multiple second bits and the difference value, and generates a corresponding converted detection result in the plurality of converted detection results according to the first value and the offset.

6. The indicator circuit of claim 5, wherein the first value is directly related to the first number of first bits, and the first value and the second value are set according to a corresponding non-linear basis in the plurality of non-linear bases.

7. The indicator circuit of claim 5, wherein the codeword mapping circuit comprises one or more lookup tables, one of the one or more lookup tables corresponds to one of the plurality of non-linear bases, the one or more lookup tables comprise a plurality of elements, respectively, and a number of the plurality of elements is determined according to the first number.

8. A calibration method, arranged to calibrate non-linear deviation of a power detection circuit, comprising:
detecting a power of an output signal of a transmitter circuit to generate a detection result;
converting the detection result according to a plurality of non-linear bases to correspondingly generate a plurality of converted detection results; and
combining the plurality of converted detection results to generate an indicator codeword.

9. The calibration method of claim 8, wherein the power of the output signal has a non-linear corresponding relationship with the detection result, the detection result has a non-linear corresponding relationship with the indicator codeword, and the power of the output signal has a linear corresponding relationship with the indicator codeword.

10. The calibration method of claim 8, wherein in response to the power of the output signal changing, a value corresponding to the indicator codeword changes correspondingly in a linear manner.

11. The calibration method of claim 8, wherein the plurality of non-linear bases are bases of different orders.

12. The calibration method of claim 8, wherein the detection result is a binary value, the binary value comprises a plurality of bits, the plurality of bits comprise multiple first bits of a first number and multiple second bits of a second number, the multiple first bits at least comprise a most significant bit (MSB) in the plurality of bits, the multiple second bits at least comprise a least significant bit (LSB) in the plurality of bits; and the step of converting the detection result according to the plurality of non-linear bases to correspondingly generate the plurality of converted detection results further comprises:
obtaining a first value and a second value according to the first number of first bits, and obtaining a difference value between the first value and the second value;
calculating an offset according to the multiple second bits and the difference value; and
generating a corresponding converted detection result in the plurality of converted detection results according to the first value and the offset.

13. The calibration method of claim 12, wherein the first value is directly related to the first number of first bits, and the first value and the second value are set according to a corresponding non-linear basis in the plurality of non-linear bases.

14. The calibration method of claim 12, wherein the first value and the second value are recorded in a lookup table, the lookup table corresponds to one of the plurality of non-linear bases, the lookup table comprises a plurality of elements, and a number of the plurality of elements is determined according to the first number.
